(19) United States
(12) Patent Application Publication
(10) Pub. No.: US 2026/0054395 A1
(43) Pub. Date: Feb. 26, 2026

(54) CONTAINER HOLDER FOR PHARMACEUTICAL CONTAINER PROCESSING SYSTEMS

(71) Applicant: Express Scripts Strategic Development, Inc., St. Louis, MO (US)

(72) Inventors: Joseph A. Siciliano, Zionsville, IN (US); Jeremy M. Pruitt, Kokomo, IN (US)

(21) Appl. No.: 18/810,603

(22) Filed: Aug. 21, 2024

(51) Int. Cl. B25J 15/02; B25J 15/00; B65B 69/00

(52) U.S. Cl. CPC B25J 15/0253; B25J 15/0019; B25J 15/0042; B65B 69/0033

(57) ABSTRACT

A container holder for holding a container in a container processing system. The container holder includes first and second jaws moveable between a gripping position and an open position. The first and second jaws holding the container when the first and second jaws are in the gripping position. The first and second jaws releasing the container when the first and second jaws move from the gripping position toward the open position. A container remover contacts the container held by the first and second jaws as the first and second jaws move from the gripping position toward the open position to remove the container from the first and second jaws should the container be stuck to the first jaw or the second jaw.

### FIELD

The present disclosure generally relates to pharmacy order processing systems, and more particularly to a container holder for pharmaceutical container processing systems, such as systems that remove pharmaceuticals from containers.

### BACKGROUND

Pharmaceutical order processing systems typically involve labor intensive processes to remove pharmaceuticals from manufacturer packaging and transfer the pharmaceuticals to a bulk storage container. Once in the bulk storage container, the pharmaceuticals can be used to fill pharmacy orders.

### SUMMARY

In one aspect, a container holder for holding a container in a container processing system comprises first and second jaws moveable between a gripping position and an open position. The first and second jaws are configured to hold the container between the first and second jaws when the first and second jaws are in the gripping position. Once gripped the jaws can move the container to different stations. The first and second jaws are configured to release the container held between the first and second jaws when the first and second jaws are moved from the gripping position toward the open position. A container remover is configured to contact the container held by the first and second jaws as the first and second jaws move from the gripping position toward the open position to remove the container from the first and second jaws should the container be stuck to the first jaw or the second jaw.

In another aspect, a container holder for holding a container in a container processing system comprises a gripper arrangeable in a gripping configuration and a release configuration. The gripper being configured to hold the container when the gripper is in the gripping configuration. The gripper is configured to release the container held by the gripper when the gripper moves from the gripping configuration toward the release configuration. A container remover is configured to contact the container held by the gripper as the gripper moves from the gripping configuration toward the release configuration to remove the container from the gripper should the container be stuck to the gripper.

Other objects and features of the present disclosure will be in part apparent and in part pointed out herein.

### BRIEF DESCRIPTION OF THE DRAWINGS

FIG. 1 is a perspective of a pharmaceutical container processing system embodying aspects of the present disclosure;

FIG. 2 is an enlarged, fragmentary perspective of a first container operation location of a pharmaceutical extractor of the pharmaceutical container processing system of FIG. 1;

FIG. 3 is an enlarged, fragmentary perspective of a second container operation location of the pharmaceutical extractor of FIG. 2, with a shroud of the pharmaceutical container processing system shown as being transparent to show components behind the shroud;

FIG. 4 is a view similar to FIG. 3 but shows a container after a opening has been cut therein;

FIG. 5 is an enlarged, fragmentary perspective of a third container operation location of the pharmaceutical extractor of FIG. 2; and

FIG. 6 is a perspective of a container holder according to one embodiment of the present disclosure with a gripper in a gripping configuration, the container holder useable in the system of FIG. 1;

FIG. 7 is another perspective of the container holder of FIG. 6;

FIG. 8 is another perspective of the container holder of FIG. 6, with the gripper in an open configuration;

FIG. 9 is a perspective of a second container striker of the container holder of FIG. 6;

FIG. 10 is a perspective of a first container striker of the container holder of FIG. 6; and

FIG. 11 is another perspective of the container holder of FIG. 6, with the gripper partially rotated and holding a container.

Corresponding reference characters indicate corresponding parts throughout the drawings.

### DETAILED DESCRIPTION

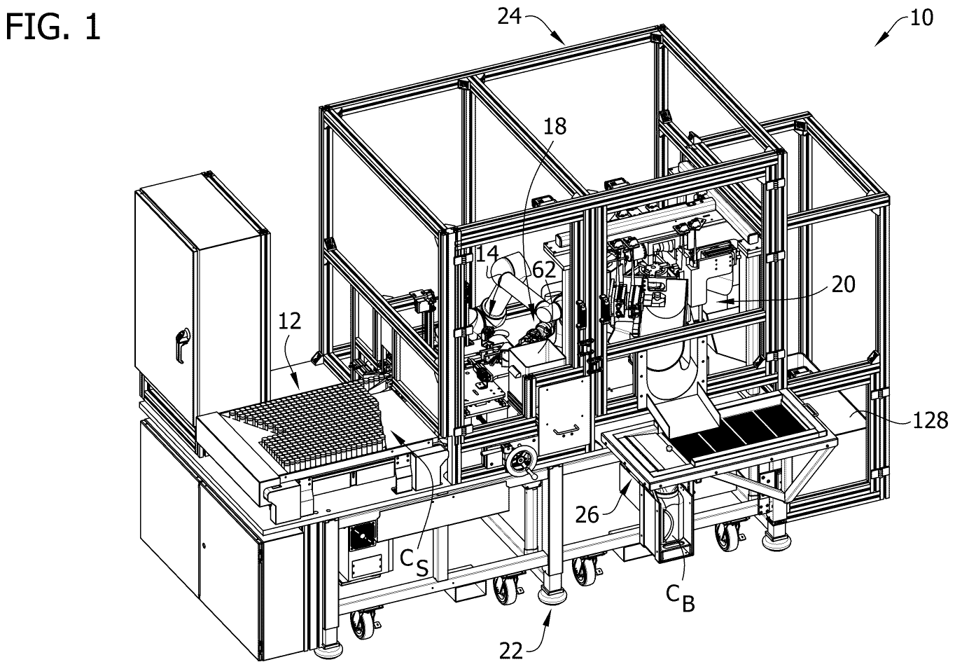

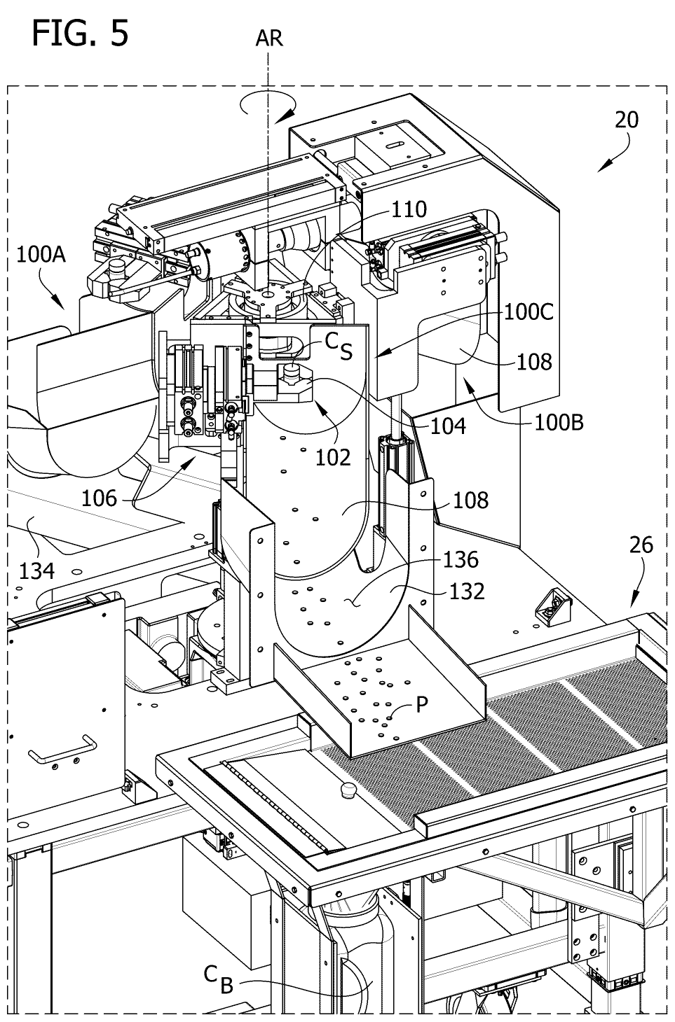

Referring to the drawings, FIGS. 1-5 illustrates a pharmaceutical container processing system, indicated generally by reference numeral 10. The pharmaceutical container processing system (e.g., a container disassembly workstation) 10 is used in a pharmaceutical order processing system, such as a high-volume pharmaceutical order processing system, to facilitate the fulfillment of a prescription order received by the pharmaceutical order processing system. The prescription order may include one or more pharmaceuticals (e.g., prescription drugs). Pharmaceutical order processing systems typically involve processes to remove pharmaceuticals P (FIG. 5) from the manufacturer's packaging, transfer the pharmaceuticals to bulk storage containers, retrieve the pharmaceuticals from the bulk storage containers and fill and package the various pharmacy orders. The pharmaceutical container processing system 10 disclosed herein is used in a pharmaceutical order processing system to remove the pharmaceuticals P from the manufacturer's packaging and transfer the pharmaceuticals to bulk storage containers. After the pharmaceuticals P are transferred to the bulk storage containers, the bulk storage containers are transported to other components of the pharmaceutical order processing system where the pharmaceuticals can be used to fill pharmacy orders. Further details on pharmaceutical order processing systems and components thereof may be found in U.S. Pat. No. 11,772,838, the entirety of which is hereby incorporated by reference. However, it will be appreciated that the systems and components disclosed herein can be used in other contexts without departing from the scope of the present disclosure.

The pharmaceutical container processing system 10 is configured to “bulk-up” pharmaceuticals P for filling orders by transferring the pharmaceuticals P contained within relatively small volume containers C_{S} into relatively large volume bulk containers C_{B}. The bulk container C_{B} can be ten or more times larger than the small volume container, e.g., about a liter in size or greater up to about four liters in volume. The pharmaceutical container processing system 10 removes the pharmaceuticals P from the small containers C_{S} in order to move the pharmaceuticals into the bulk container C_{B}.

The pharmaceutical container processing system 10 includes a hopper, generally indicated by reference numeral 12, a container transporter, generally indicated by reference numeral 18, and a pharmaceutical extractor, generally indicated by reference numeral 20. The pharmaceutical container processing system 10 includes a frame 22 supporting the various components of the system. An enclosure or cover assembly 24 is attached to the frame 22 and covers at least the container transporter 18 and the pharmaceutical extractor 18 to protect operators from being exposed to the pharmaceuticals P as the pharmaceuticals are transferred from the small containers C_{S} to the bulk container C_{B}. In various drawings herein, the cover assembly 24 is removed to more clearly show other components. Desirably, the cover assembly 24 is transparent to permit the operator to view the operation of the pharmaceutical container processing system 10. Other configurations of the pharmaceutical container processing system 10 are within the scope of the present disclosure. Moreover, the pharmaceutical container processing system 10 may not include all of the above listed components or additional components. For example, in the illustrated embodiment, the pharmaceutical container processing system 10 also includes a pharmaceutical collector, generally indicated by reference numeral 26, for loading the pharmaceuticals P into the bulk container C_{B}.

Referring to FIG. 1, the hopper 12 is configured to hold many (e.g., a plurality of) containers, such as the small containers C_{S}, and to dispense the containers from the hopper. For example, the hopper 12 may be configured to hold hundreds of small containers C_{S}. Operators place the containers C_{S} in or on the hopper 12, where the containers are held and stored until the containers are moved (e.g., dispensed) to other components of the pharmaceutical container processing system 10. In the illustrated embodiment, the hopper 12 holds small containers C_{S}, although it is understood the hopper may hold containers of generally any size. Further details on the hopper 12 may be found in U.S. Pat. No. 11,772,838, the entirety of which is incorporated herein by reference. The small containers C_{S} are singulated (by a singulator assembly) and picked up by the container transporter 18. The container transporter 18 is configured to move the containers C_{S} to the pharmaceutical extractor 20. In the illustrated embodiment, the container transporter 18 is a robot such as a six-axis robotic arm, a selective-compliance-articulated robotic arm, a cylindrical robot, a delta robot, a polar coordinate robot, a vertically articulated robot, a Cartesian coordinate robot or any other suitable device. Further details on the container transporter 18 may be found in U.S. Pat. No. 11,772,838, the entirety of which is incorporated by reference above.

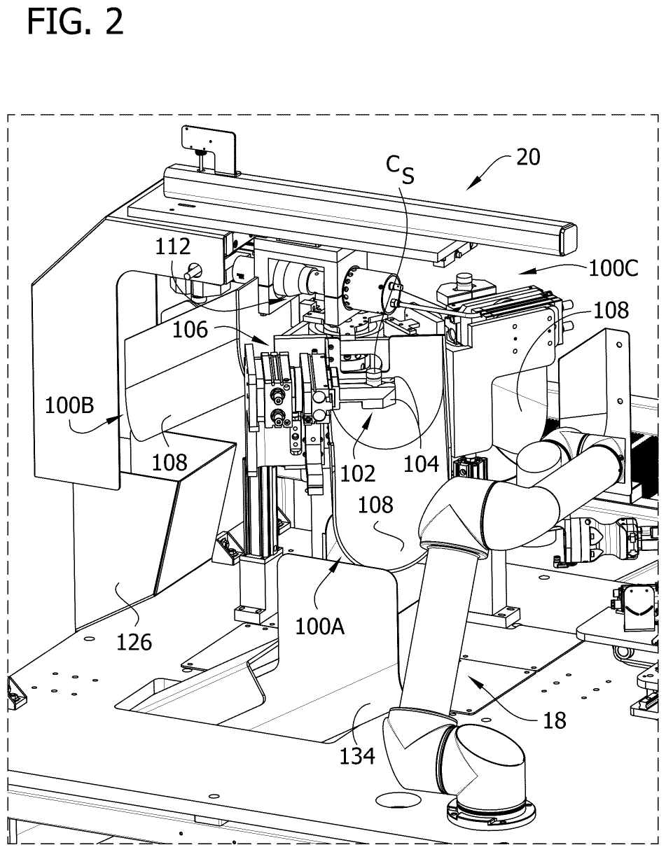

Referring to FIGS. 2-5, the pharmaceutical extractor 20 is configured to remove the pharmaceuticals P from the containers C_{S}. The pharmaceutical extractor 20 includes a plurality of holders 100A-C, each holder configured to hold a container C_{S} (broadly, at least one container). Specifically, each holder 100A-C includes a gripper 102 configured to hold one container C_{S}. Each gripper 102 is configured to selectively grab, retain and release the container C_{S}. In the illustrated embodiment the gripper 102 includes two selectively movable jaws 104, although other configurations are within the scope of the present disclosure. Each holder 100A-C includes an actuator assembly 106, including one or more actuators (such as but not limited to one or more linear actuators and/or rotary actuators) to open and close the gripper 102 (e.g., move the jaws 104) to selectively grab and release the container C_{S}. The actuator assembly 106 can also rotate the gripper 102 and shake the gripper, as discussed in more detail below. In addition, each holder 100A-C includes a discharge chute 108 disposed below the gripper 102 and configured to catch and guide the pharmaceuticals P contained in each container C_{S} and the container or portions thereof to other components of the pharmaceutical container processing system 10, as described in more detail below. In the illustrated embodiment, the pharmaceutical extractor 20 includes three holders 100A-C (e.g., a first holder, a second holder and a third holder), although more or fewer holders are within the scope of the present disclosure.

Each holder 100A-C is configured to move between a plurality of different stations or locations (e.g., container operation locations) of the pharmaceutical extractor 20. The pharmaceutical extractor 20 is a progressive, multi-stage disassembly device that moves each holder 100A-C and container C_{S} held thereby through the different steps for removing the pharmaceuticals P from the container. In the illustrated embodiment, the pharmaceutical extractor 20 includes three locations (e.g., a first location, a second location and a third location) for each holder 100A-C to move to. The holders 100A-C cycle through the three locations in series, one holder after another holder, to extract the pharmaceuticals P from the containers C_{S}. In this embodiment, the holders 100A-C cycle through the series of locations by rotating through the three locations. Moreover, as will become apparent, the pharmaceutical extractor 20 repeatedly cycles the holders 100A-C through the series of locations to perform the series of operations on additional containers C_{S}, to extract the pharmaceuticals P from the additional containers. Each holder 100A-C is mounted to a shaft 110 that defines an axis of rotation AR the shaft and holders rotate about. As shown in FIGS. 2-5, the first holder 100A is disposed in the first location, the second holder 100B is disposed in the second location and the third holder 100C is in the third location. Each holder 100A-C moves, in order, from the first location, to the second location, to the third location and then back to the first location to repeat the cycle. The first location may be considered a pickup/drop-off location, the second location may be considered a cutting location, and the third location may be considered a pharmaceutical unloading location.

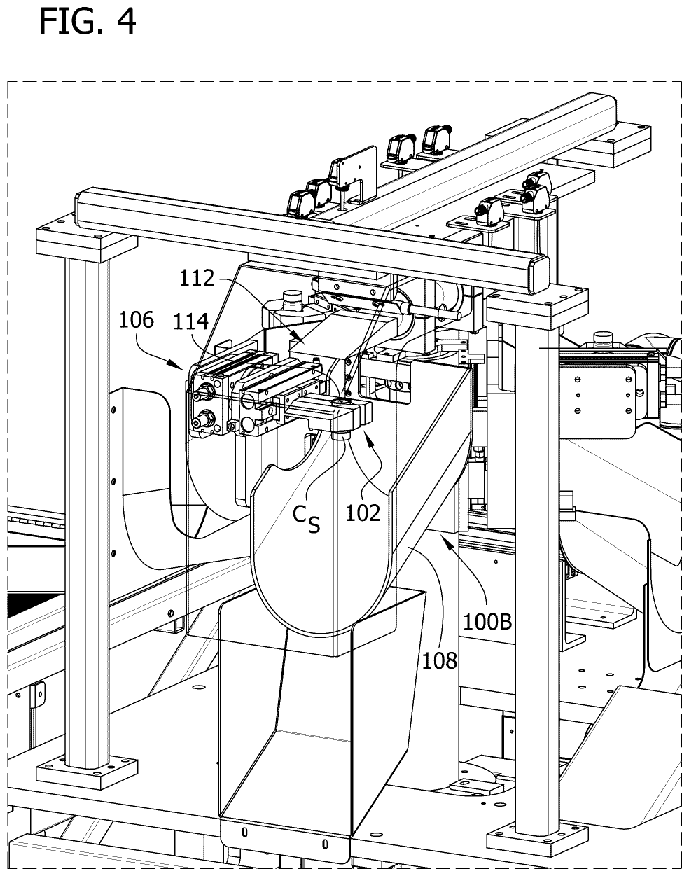

Referring to FIG. 2, each holder 100A-100C is configured to receive one of the containers C_{S}. In particular, the gripper 102 of each holder 100A-100C receives the container C_{S} when each holder is at the first location. The container transporter 18 picks up the container C_{S} and delivers the container to the holder 100A-C at the first location. The container transporter 18 positions the container C_{S} in a position such that when the gripper 102 of the holder 100A-100C at the first location closes, the gripper holds and retains the container. After the gripper 102 of the holder 100A-100C secures the container C_{S}, the container transporter 18 releases its hold on the container and moves to grab another container to be delivered to another holder of the pharmaceutical extractor 20. Preferably, the gripper 102 inverts (e.g., flips over, rotates about 180 degrees) the container C_{S} so that the bottom of the container is facing upwards, as shown in FIG. 4. As mentioned above, the actuator assembly 106 includes a rotary actuator to rotate the gripper 102 and invert the container C_{S}. Once the container C_{S} is secured in the holder 100A-100C, the holder is moved to the second location.

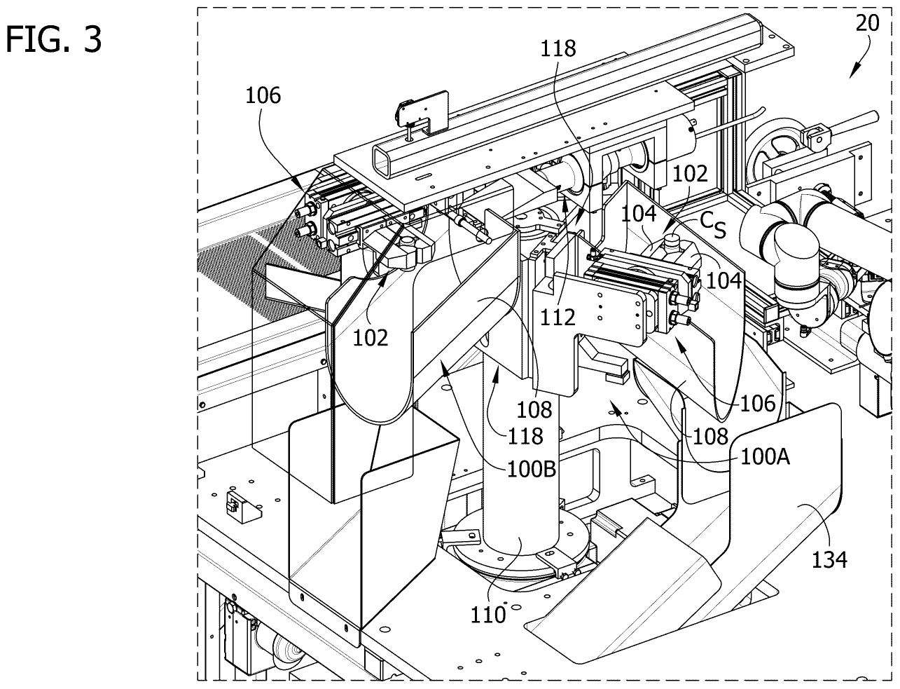

Referring to FIGS. 3 and 4, the pharmaceutical extractor 20 includes a cutter 112 disposed at the second location. The cutter 112 is configured to cut the container C_{S} held by the gripper 102 of the holder 100A-C to create a pharmaceutical opening or outlet 114 in the container. Specifically, the cutter 112 creates the pharmaceutical outlet 114 in the container C_{S} when the container and corresponding holder 100A-C holding the container are at the second location. In the illustrated embodiment, the cutter 112 cuts off a bottom portion of the container C_{S} (which is facing upwards) to form the pharmaceutical outlet 114. Further details on the cutter 112 and other associated cutting components may be found in U.S. Pat. No. 11,772,838, the entirety of which is incorporated by reference above. The holders 100A-C may include a lifting actuator 118 (e.g., a linear actuator) operatively connected to and between the gripper 102 and the shaft 110 to move the container C_{S} upward into the path of cutter 112. After the pharmaceutical outlet 114 has been created in the container C_{S}, the container and holder 100A-C are moved to the third location.

Referring to FIG. 5, the pharmaceutical extractor 20 includes a pharmaceutical collection inlet 136 located along the series of locations, downstream from the cutter 112. The pharmaceutical collection inlet 136 is disposed at the third location, and is defined by a pharmaceutical chute 132 which directs the pharmaceuticals P to the pharmaceutical collector 26. The pharmaceutical collection inlet 136 receives the pharmaceuticals P from the pharmaceutical outlets 114 in the containers C_{S}. The pharmaceuticals P in the container C_{S} move through the pharmaceutical outlet 114 and out of the container when the container is at the third location. Each holder 100A-C is configured to move the container C_{S} so that the pharmaceuticals P in the container flow through the pharmaceutical outlet 114. In particular, the gripper 102 of each holder 100A-C moves the container C_{S} from the inverted orientation (broadly, a first orientation) to an upright or non-inverted orientation (broadly, a second orientation). The gripper 102 is rotated by the actuator assembly 106 of the holder 100A-C. In the upright orientation, as shown in FIG. 5, the pharmaceuticals P, under the influence of gravity, move through pharmaceutical outlet 114, out of the container C_{S} and into the pharmaceutical collection inlet 136. The operator can shift through the pharmaceuticals P received by the pharmaceutical collector 26 to remove damaged or broken pharmaceuticals and other contaminants while additional pharmaceuticals are removed from the containers C_{S}. Further details on the pharmaceutical collector 26 are described in U.S. patent application Ser. No. 16/226,944, the entirety of which is hereby incorporated by reference. After the pharmaceuticals P move out of the container C_{S}, the container and holder 100A-C are moved back to the first location.

Referring back to FIG. 2, upon returning to the first location with the now empty container C_{S}, the gripper 102 of the holder 100A-C releases the container. In other words, the gripper 102 of the holder 100A-C is configured to receive the container C_{S} when the holder is at the first location during a first period of time (e.g., the first time the container is at the first location) and is configured to release the container when the holder is at the first location during a second period of time, different than the first period of time (e.g., upon the container returning to the first location). When the container C_{S} is released by the gripper 102, the container falls into another waste chute 134 which directs the empty container C_{S} to the waste bin 128 (FIG. 1). The container C_{S} may fall directly into the waste chute 134 or fall into the discharge chute 108 which directs the container to the waste chute. After the gripper 102 releases the empty container C_{S}, the gripper is ready to receive another container from the container transporter 18, and the cycle repeats.

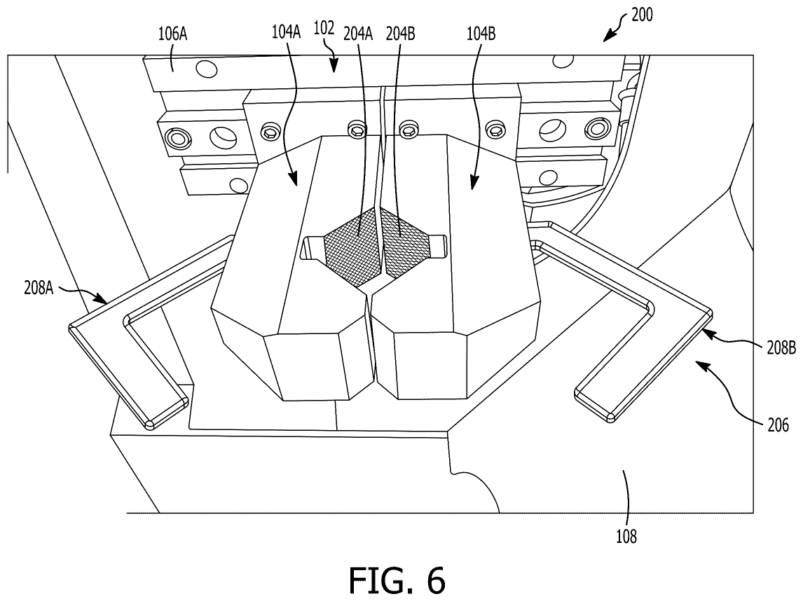

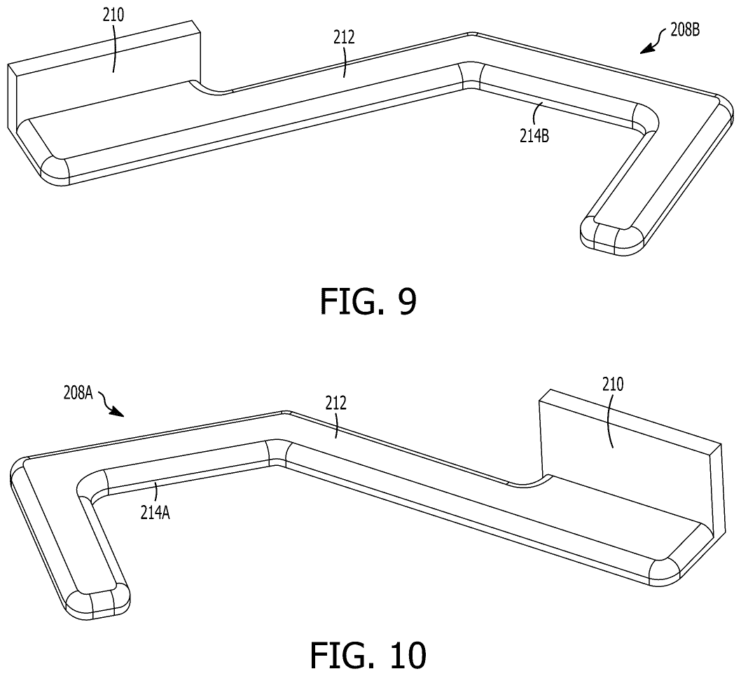

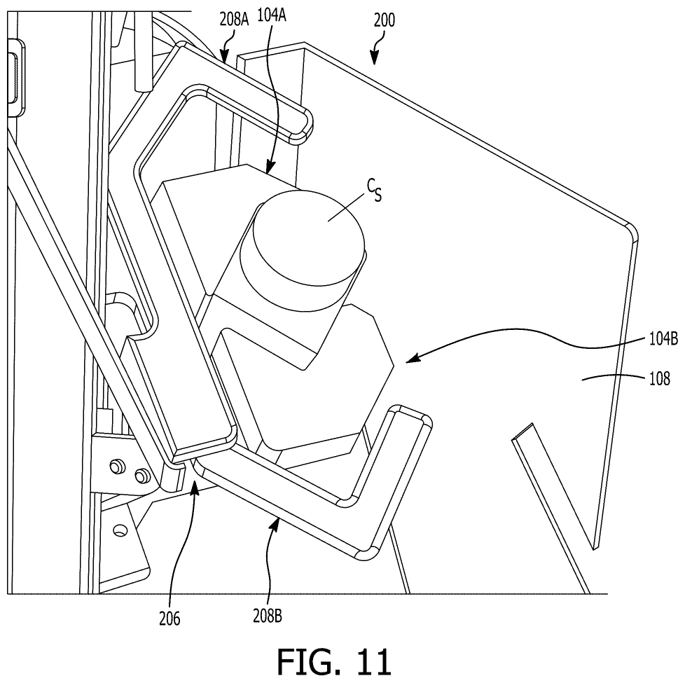

Referring to FIGS. 6-11, a container holder according to one embodiment of the present disclosure is generally indicated at reference numeral 200. The holder 200 shown in FIGS. 6-11 may be one of the holders 100A-C used in the container extractor 20 as described herein. It is understood the container extractor 20 may include three holders 200 of FIGS. 6-11. In other examples, there can more than three holders. Unless clearly stated or indicated otherwise, the description of the holders 100A-C of FIGS. 1-5 also apply to the holder 200 of FIGS. 6-11.

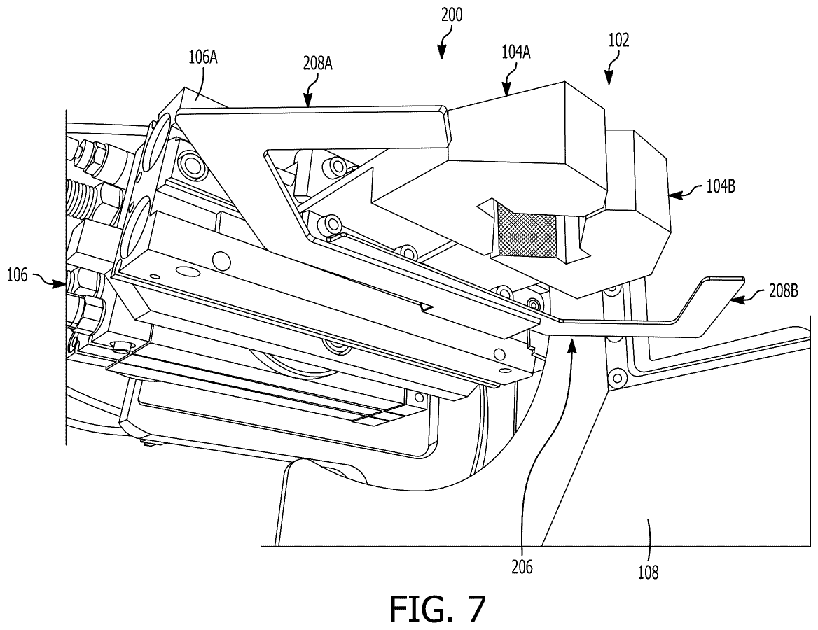

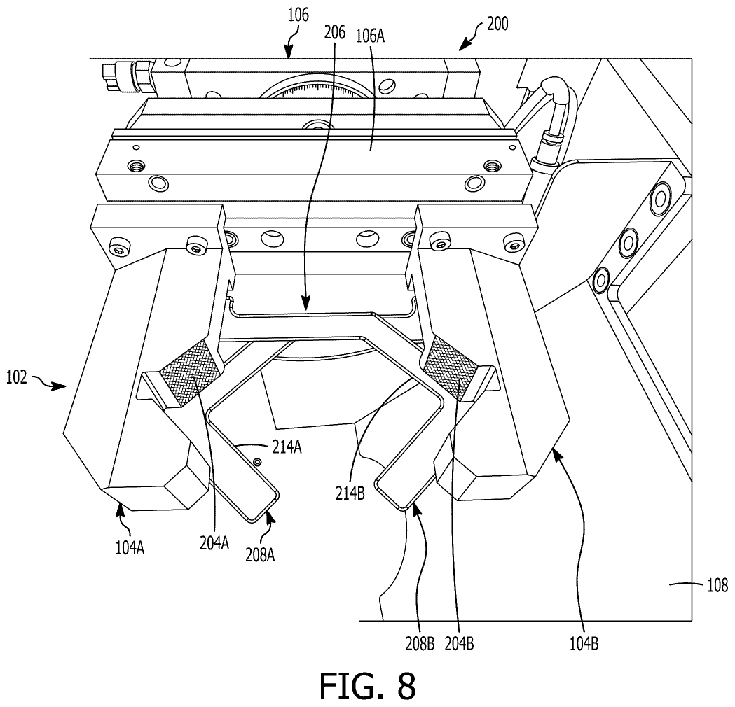

In this embodiment, the holder 200 includes a gripper 102 configured to hold a container C_{S}. The gripper 102 is configured to selectively grab, retain and release the container C_{S}. The gripper 102 is arrangeable in a first or gripping configuration (FIGS. 6 and 7) and a second or release configuration (FIG. 8). The gripper 102 holds the container C_{S} when the gripper is in the gripping configuration. The gripper 102 releases the container C_{S} held by the gripper when the gripper moves from the gripping configuration toward the release configuration. The gripper 102 includes first and second jaws 104A, 104B moveable between a first, closed, or gripping position (FIGS. 6 and 7) and a second or open position (FIG. 8). The first and second jaws 104A, 104B hold the container C_{S} between the first and second jaws when the first and second jaws are in the gripping position (e.g., when the gripper 102 is in the gripping configuration). The first and second jaws 104A, 104B release the container C_{S} held between the first and second jaws when the first and second jaws are moved from the gripping position toward the open position (e.g., when the gripper 102 is moved or rearranged from the gripping configuration to the open configuration). The first and second jaws 104A, 104B move inward, toward one another, when moving toward the gripping position. The first and second jaws 104A, 104B move outward, away from one another, when moving toward the open position.

The first and second jaws 104A, 104B are operatively coupled to the actuator assembly 106 (e.g., one or more linear actuators thereof) for moving the first and second jaws between the gipping position and the open position. The first and second jaws 104A, 104B each include a container gripping surface 204A, 204B (e.g., respective first and second container gripping surfaces). The container gripping surfaces 204A, 204B are arranged to contact and hold the container C_{S} when the jaws 104A, 104B are in the gripping position. The container gripping surfaces 204A, 204B may be shaped to correspond to the shape of the container C_{S}. In the illustrated embodiment, the container gripping surfaces 204A, 204B have a V-shape, which are suitable for use in holding round and square shaped containers C_{S}. The container gripping surfaces 204A, 204B may have other shapes, such as planar, curved, semi-circular, etc., without departing from the scope of the present disclosure. The first and second jaws 104A, 104B are mounted to a support 106A. The support 106A may be part of the actuator assembly 106. For example, in the illustrated embodiment, the support 106A defines tracks along which the jaws 104A, 104B move as the jaws move between the gripping position and the open position. Other configurations of the gripper may be used without departing from the scope of the present disclosure.

In some instances, a container may have adhesive on outside of the label or on the surface of the container contacted by the gripper jaws 104A, 104B. This can result in the container being stuck to one of the grippers 104A, 104B.

In this embodiment, the holder 200 includes a container remover 206. Occasionally, the containers C_{S} may stick to or otherwise remain attached to the gripper 102 (e.g., one of the jaws 104A, 104B thereof) even when the jaws are moved toward the open position. This can be due to an exposed adhesive (e.g., a pressure sensitive adhesive) on the surface of the containers C_{S}, such as the adhesive used to apply a label to the outside of the container. In this case, the container C_{S} will not simply fall down when the jaws 104A, 104B are opened (e.g., moved toward the open position), such as when the holder 200 returns to the first location as described above to drop the container, as the adhesive keeps the container attached to one of the jaws. It then becomes necessary to physically remove the container C_{S} from the gripper 102. The container remover 206 contacts the container C_{S} held by the gripper 102 as the gripper moves from the gripping configuration toward the release configuration to remove the container from the gripper should the container be stuck to the gripper. In particular, the container remover 206 contacts the container C_{S} held by the first and second jaws 104A, 104B as the first and second jaws move from the gripping position toward the open position to remove the container from the first and second jaws should the container be stuck to the first jaw or the second jaw. Therefore, the container remover 206 ensures the container C_{S} falls down from the gripper 102 when the gripper is opened to release the container.

The container remover 206 includes first and second container strikers or strippers 208A, 208B. The first container striker 208A is configured to contact the container C_{S} and dislodge the container from the first jaw 104A should the container be stuck to the first jaw as the first and second jaws 104A, 104B move from the gripping position toward the open position. Similarly, the second container striker 208B is configured to contact the container C_{S} and dislodge the container from the second jaw should the container be stuck to the second jaw as the first and second jaws 104A, 104B move from the gripping position toward the open position. In general, the first jaw 104A generally moves past the first container striker 208A when moving from the gripping position to the open position such that if the container C_{S} is stuck to the first jaw, the first container striker 208A will contact the container and separate the container from the first jaw. Similarly, the second jaw 104B generally moves past the second container striker 208B when moving from the gripping position to the open position such that if the container C_{S} is stuck to the second jaw, the second container striker 208A will contact the container and separate the container from the second jaw.

The container strikers 208A, 208B are generally mirror images of one another. Each container striker 208A, 208B includes a mounting flange 210 for attaching the container striker to the rest of the holder 200 and an arm 212 for contacting the container C_{S}. In the illustrated embodiment, the arm 212 is composed of three linear segments or sections that form a generally hook shape. The mounting flange 210 of one of the container strikers 208A, 208B may be taller than the other mounting flange to allow the arms 212 to overlap one another, as shown in FIGS. 7 and 8. The container strikers 208A, 208B may be made of metal (e.g., sheet metal), polymer, or plastic. In an example, the container strikers can be formed of carbon fiber or other laminated materials. The container strikers may also be formed from composites of these materials. Other constructions materials may be used without departing from the scope of the present disclosure just as long as the strikers are rigid enough to force the containers from the grippers. In some embodiments, the container strikers can have a curved blade or bent blade structure with the length and the depth being significantly longer than the height. Each container striker 208A, 208B includes a contact surface or edge 214A, 214B (e.g., respective first and second contact surfaces). In an embodiment, the contact surface or edge 214A, 214B are the height in the blade embodiments. The contact edge 214A, 214B can be thinner than the main body of the strikers 208A, 208B. The contact edge 214A or 214B, in an example embodiment, is thin but not thin enough to cut into the container or the label on the container, e.g., the contact edges are not sharp. The contact surfaces 214A, 214B are configured to contact the container C_{S}. The contact surfaces 214A, 214B have a smaller contact area on the container smaller than the area of the grippers contacting the container 204A, 204B (e.g., by orders of magnitude less. In an exemplary embodiment, the shape of the contact surfaces 214A, 214B corresponds to the respective shapes of the container gripping surfaces 204A, 204B. In the illustrated embodiment, the contact surfaces 214A, 214B each have a V-shape to correspond to the V-shape of the container gripping surfaces 204A, 204B. The contact surfaces 214A, 214B may have other shapes, such as planar, curved, semi-circular, etc., without departing from the scope of the present disclosure. Other configurations of the container strikers may be used without departing from the scope of the present disclosure.

Desirably, the contact surfaces 214A, 214B of the container strikers 208A, 208B are positioned at an elevation close to the jaws 104A, 104B. This minimized any rotation on the container C_{S} imparted by the container strikers 208A, 208B when contacting the container and removing the container from the jaws 104A, 104B. This helps keep the container C_{S} in a vertical orientation as the container falls from the gripper, making it easier to control the fall of the container as it slides along the hopper 108 and/or chute 134. A rotating container C_{S} is more uncontrollable and my bounce around the system 10, potentially landing in undesirable areas of the system. The container strikers 208A, 208B are thin and flat (e.g., blade like) to enable them to be closely positioned next to the jaws 104A, 104B. In the illustrated embodiment, the first container striker 208A underlies the first jaw 104A and the second container striker 208B underlies the second jaw 104B. The first container stricker 208A (e.g., the arm 212 thereof) also underlies the second container striker 208B (e.g., the arm 212 thereof). In other embodiments, the container strikers may overlie the jaws.

With the first and second jaws 104A, 104B in the open position (FIG. 8), the first contact surface 214A of the first container striker 208A is arranged inward of the first jaw 104A (specifically, the first container gripping surface 204A) and the second contact surface 214B of the second container striker 208B is arranged inward of the second jaw 104B (specifically, the second container gripping surface 204B). With the first and second jaws 104A, 104B in the gripping position (FIGS. 6 and 7), the first contact surface 214A of the first container striker 208A is arranged outward of the first jaw 104A (specifically, the first container gripping surface 204A) and the second contact surface 214B of the second container striker 208B is arranged outward of the second jaw 104B (specifically, the second container gripping surface 204B). This arrangement ensures the container strikers 208A, 208B will not interfere with the ability of the jaws 104A, 104B to hold the container C_{S} while also ensuring the container strikers come into contact with the container should the container be stuck on the jaws.

In the illustrated embodiment, the container strikers 208A, 208B are moveable. This enables the container remover 206 to be arrangeable in a closed configuration (FIG. 8) and an open configuration (FIGS. 6 and 7). The container remover 206 contacts the container C_{S} as the container remover moves from the open configuration toward to the closed configuration to remove the container from the gripper 102 should the container be stuck to the gripper. The container remover 206 is in the closed configuration when the gripper 102 is in the release configuration and is in the open configuration when the gripper is in the gripping configuration. The container remover 206 generally moves in the opposite direction as the gripper 102. The container remover 206 moves toward the closed configuration as the gripper 102 moves toward the release configuration and moves toward the open configuration as the gripper moves toward the gripping configuration. The first container striker 208A moves in the opposite direction to that of the first jaw 104A—e.g., when the first jaw moves inward the first container striker moves outward and vice versa. Likewise, the second container striker 208B moves in the opposite direction to that of the second jaw 104B—e.g., when the second jaw moves inward the second container striker moves outward and vice versa.

In the closed configuration, the container strikers 208A, 208B are in a first or closed position. In the open configuration, the container strikers 208A, 208B are in a second or open position. The container strikers 208A, 208B move inward as they move from the open position toward the closed position. The first container striker 208A moves into contact with the container C_{S} and dislodges the container from the first jaw 104A should the container be stuck to the first jaw as the container remover 206 moves from the open configuration toward the closed configuration (e.g., as the first container striker moves from the open position toward the closed position). Similarly, the second container striker 208B moves into contact with the container C_{S} and dislodges the container from the second jaw 104B should the container be stuck to the second jaw as the container remover 206 moves from the open configuration toward the closed configuration (e.g., as the second container striker moves from the open position toward the closed position). The actuator assembly 106 is operatively coupled to the container remover 206 (e.g., container strikers 208A, 208B) for moving the container remover between the open and closed configurations. In one embodiment, the first container striker 208A moves with the second jaw 104B and the second container striker 208B moves with the first jaw 104A. This reduces the number of actuators needed to move the jaws 104A, 104B and the container strikers 208A, 208B. In the illustrated embodiment, the first container striker 208A is mounted to and moves with the second jaw 104B and the second container striker 208B is mounted to and moves with the first jaw 104A. The container strikers 208A, 208B may be mounted via one or more fasteners extending through the mounting flanges 210. Other configuration may be used without departing from the scope of the present disclosure. For example, the actuator assembly can include separate linear actuators for controlling the movement of the container strikers independent of the movement of the jaws.

The strikers having a smaller area contacting the containers relative to the grippers provides a smaller area for stray adhesive on the container to adhere to the striker relative to the grippers. The empty container is lighter after the pills (or other contents in the container) are removed. The stray adhesive on the container in contact with a gripper sometimes has enough non-reactive adhesive bond strength to adhere the container to the gripper when the grippers are opened. The adhesive can be a food grade or pharmaceutical grade pressure-sensitive adhesive or a food grade or pharmaceutical grade contact sensitive adhesive. In some cases, the machine must be stopped for a technician to reach in and remove the adhered container. The presently described strikers with a smaller contact area on the container can force the stuck container from the gripper automatically without human action. The small contact area reduces the chance of the container adhering to the striker.

In other embodiments, the container strikers are not moveable. The container strikers are not mounted to and moveable with the jaws. Instead, the container strikers are mounted in a fixed location, such as to the support 106A. In this embodiment, the jaws move relative to the stationary container strikers. Other configurations may be used without departing from the scope of the present disclosure.

The Title, Field, and Background are provided to help the reader quickly ascertain the nature of the technical disclosure. They are submitted with the understanding that they will not be used to interpret or limit the scope or meaning of the claims. They are provided to introduce a selection of concepts in simplified form that are further described in the Detailed Description. The Title, Field, and Background are not intended to identify key features or essential features of the claimed subject matter, nor is it intended to be used as an aid in determining the claimed subject matter.

When introducing elements of aspects of the disclosure or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the aspects of the disclosure are achieved and other advantageous results attained.

Not all of the depicted components illustrated or described may be required. In addition, some implementations and embodiments may include additional components.

Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the aspects of the disclosure by way of example and not by way of limitation. This description enables one skilled in the art to make and use the aspects of the disclosure, and describes several embodiments, adaptations, variations, alternatives and uses of the aspects of the disclosure, including what is presently believed to be the best mode of carrying out the aspects of the disclosure. Additionally, it is to be understood that the aspects of the disclosure is not limited in its application to the details of construction and the arrangement of components set forth in the description or illustrated in the drawings. The aspects of the disclosure are capable of other embodiments and of being practiced or carried out in various ways. Also, it will be understood that the phraseology and terminology used herein is for the purpose of description and should not be regarded as limiting.

Having described aspects of the disclosure in detail, it will be apparent that modifications and variations are possible without departing from the scope of aspects of the disclosure as defined in the appended claims. It is contemplated that various changes could be made in the above constructions, products, and methods without departing from the scope of aspects of the disclosure. In the preceding specification, various embodiments have been described with reference to the accompanying drawings. It will, however, be evident that various modifications and changes may be made thereto, and additional embodiments may be implemented, without departing from the broader scope of the aspects of the disclosure as set forth in the claims that follow. The specification and drawings are accordingly to be regarded in an illustrative rather than restrictive sense.

What is claimed is:

1. A container holder for holding a container in a container processing system, the container holder comprising:
first and second jaws moveable between a gripping position and an open position, the first and second jaws being configured to hold the container between the first and second jaws when the first and second jaws are in the gripping position, the first and second jaws being configured to release the container held between the first and second jaws when the first and second jaws are moved from the gripping position toward the open position; and
a container remover configured to contact the container held by the first and second jaws as the first and second jaws move from the gripping position toward the open position to remove the container from the first and second jaws should the container be stuck to the first jaw or the second jaw.

2. The container holder of claim 1, wherein the container remover includes a first container striker configured to contact the container and dislodge the container from the first jaw should the container be stuck to the first jaw as the first and second jaws move from the gripping position toward the open position.

3. The container holder of claim 2, wherein the container remover includes a second container striker configured to contact the container and dislodge the container from the second jaw should the container be stuck to the second jaw as the first and second jaws move from the gripping position toward the open position.

4. The container holder of claim 3, wherein the first container striker includes a first contact surface configured to contact the container and the second container striker includes a second contact surface configured to contact the container.

5. The container holder of claim 4, wherein the first and second jaws move inward, toward one another, when moving from the open position toward the gripping position, wherein the first contact surface of the first container striker is arranged inward of the first jaw and the second contact surface of the second container striker is arranged inward of the second jaw when the first and second jaws are in the open position.

6. The container holder of claim 5, wherein the first jaw includes a first container gripping surface and the second jaw includes a second container gripping surface, the shape of the first container gripping surface corresponding to the shape of the first contact surface of the first container striker, the shape of the second container gripping surface corresponding to the shape of the first contact surface of the first container striker.

7. The container holder of claim 6, wherein the first and second container gripping surfaces and the first and second contact surfaces each have a V-shape.

8. The container holder of claim 3, wherein the first container striker underlies the first jaw and the second container striker underlies the second jaw.

9. The container holder of claim 7, wherein the first container striker underlies the second container striker.

10. The container holder of claim 1, further comprising an actuator assembly operatively coupled to the first and second jaws for moving the first and second jaws between the gripping and open positions.

11. A container holder for holding a container in a container processing system, the container holder comprising:
a gripper arrangeable in a gripping configuration and a release configuration, the gripper being configured to hold the container when the gripper is in the gripping configuration, the gripper being configured to release the container held by the gripper when the gripper moves from the gripping configuration toward the release configuration; and
a container remover configured to contact the container held by the gripper as the gripper moves from the gripping configuration toward the release configuration to remove the container from the gripper should the container be stuck to the gripper.

12. The container holder of claim 11, wherein the container remover is arrangeable in a closed configuration and an open configuration, the container remover is configured to be in the closed configuration when the gripper is in the release configuration and is configured to be in the open configuration when the gripper is in the gripping configuration.

13. The container holder of claim 12, wherein the container remover is configured to move toward the closed configuration as the gripper moves toward the release configuration and is configured to move toward the open configuration as the gripper moves toward the gripping configuration.

14. The container holder of claim 13, wherein the container remover is configured to contact the container as the container remover moves from the open configuration toward to the closed configuration to remove the container from the gripper should the container be stuck to the gripper.

15. The container holder of claim 14, wherein the gripper includes moveable first and second jaws, the first and second jaws being configured to hold the container between the first and second jaws when the gripper is in the gripping configuration, the first and second jaws being configured to release the container held between the first and second jaws when the gripper moves from the gripping configuration toward the release configuration.

16. The container holder of claim 15, wherein the container remover includes moveable first and second container strikers, the first container striker configured to move into contact with the container and dislodge the container from the first jaw should the container be stuck to the first jaw as the container remover moves from the open configuration toward the closed configuration, the second container striker configured to move into contact with the container and dislodge the container from the second jaw should the container be stuck to the second jaw as the container remover moves from the open configuration toward the closed configuration.

17. The container holder of claim 16, wherein the first container striker is configured to move in the opposite direction as the first jaw and the second container striker is configured to move in the opposite direction as the second jaw.

18. The container holder of claim 16, wherein the first container striker is configured to move with the second jaw, and the second container striker is configured to move with the first jaw.

19. The container holder of claim 18, wherein the first container striker is mounted to and moves with the second jaw and the second container striker is mounted to and moves with the first jaw.

20. The container holder of claim 19, further comprising an actuator assembly operatively coupled to the gripper and the container remover for moving the gripper between the gripping and release configurations and for moving the container remover between the open and closed configurations.
